(19) United States
(12) Patent Application Publication
(10) Pub. No.: US 2007/0022616 A1
(43) Pub. Date: Feb. 1, 2007

(54) Easy mark ruler

(76) Inventor: Jerry Salvatore Trainello, Sarasota, FL (US)

Correspondence Address: JERRY S. TRAINELLO, 4947 TAYWATER DELL, SARASOTA, FL, 34235, US

(21) Appl. No.: 11/141,224

(22) Filed: May 31, 2005

(51) Int. Cl. B43L 7/00

(52) U.S. Cl. 33/492

(57) ABSTRACT

A tool for measuring and marking material, the tool is formed of an elongated sheet of rigid material such as wood, plastic or metal. Having on one edge of the sheet of rigid material, a series of equally spaced notches (6) that are sized to fit the point of a marking instrument or pencil (10). Also on the body of the sheet of rigid material is a series of equally spaced through-holes (8) that are also sized to fit the point of a marking instrument or pencil (10). The equally spaced notches (6) and through-holes (8) are in inches or millimeters or a combination of both. The elongated sheet of rigid material with the inclusion of notches (6) and through-holes (8) enable a person to measure and mark accurately and quickly.

### CROSS REFERENCE TO RELATED APPLICATIONS

This is a pre-amendment of application Ser. No. 11/141,224 Art unit: 2859

### BACKGROUND OF THE INVENTION

1. Field of Invention

The present invention relates to an everyday tool for measuring that we all have seen and used in particular the conventional ruler. A ruler can be made of any rigid material such as wood, metal or plastic. The conventional ruler has a major disadvantage, that is the difficulty of marking accurately and quickly. Over the years the applicant has read numerous articles written in trade publications on suggestions and techniques for measuring and marking with a ruler accurately. Still the basic ruler has remained the same for decades.

2. Prior Art

Rulers are well known to be elongated and rectangular in shape and have indications for marking in inches, millimeters, fractions of an inch or fractions of a millimeter. These rulers are made of most rigid materials such as wood, plastic or metal. Applicant is aware of rulers for measuring and cutting, such as U.S. Pat. No. 6,851,196 and U.S. Pat. No. 6,854,189. These inventions are developed to perform a particular function such as cutting or marking large sheets of material. U.S. Pat. No. 6,247,240 have grooves and t-slots in the ruler's surface for attaching accessories. Applicant is not aware of any prior art that utilizes notches or through-holes on the surface of the conventional ruler as an aid for marking and measuring accurately.

### BRIEF SUMMARY OF THE INVENTION

The magazines articles I mentioned above all have one thing in common, either a person is asking about a method of marking accurately and consistently with a ruler, or someone is suggesting a method of measuring and marking more accurately and consistently with a ruler.

All of the measuring techniques suggested in these articles are helpful. As an example in an article in Fine Woodworking June 2004 under the headline “More measuring tips.”

The author suggests a tip that his father taught him and his fellow craftsmen at the Boeing Company in W.W.II for measuring and marking accurately. “Leave the ruler's reference point stationary and calculate the distances of each needed point from the reference point. He goes on to mention if you move the ruler from point to point to make the measurements, even minor variations from dead center will accumulate to yield major inaccuracies by the time you are finished.” This not only suggests how difficult it is to mark and measure accurately, but also that the divisions on a ruler no matter how precise they may be depend on the skill of the person using the ruler.

Some measurement inaccuracies occur due to the design of some rulers. The units on rulers can be very difficult to read under the light commonly found in the typical work area. The material used in constructing the ruler can cause a glare causing the person reading the ruler to mark incorrectly.

In view of all of the above it would be a benefit to anyone who uses a ruler to have a marking instrument that can measure and mark accurately without depending on conditions, or the skill of the person using the ruler.

The present invention 4 with the inclusion of notches, indents or grooves 6 and holes 8 on one or both edges of the conventional ruler 2 corrects the problem of marking accurately. Adding the notches and holes converts the conventional ruler 2 into an accurate marking tool.

The applicant would also like to point out that this improvement to the conventional ruler 2 is a definite aid to the blind.

It will become clear that the notches and holes make it possible for the blind or people with bad eyesight to measure by touch with the present invention 4.

### BRIEF DESCRIPTION OF THE DRAWING

FIG. 1 is a partial view of a conventional ruler 2.

FIG. 2 is a partial view illustrating the overall structure of the present invention 4.

FIG. 3 is a partial view of point 12 making a mark in hole 8 in accordance with the present invention 4.

FIG. 4 is a partial view of point 12 making a mark in notch 6 in accordance with the present invention 4.

FIG. 5 illustrates alternate embodiments of the present invention 4.

### DRAWING—REFERENCE NUMERALS

2—conventional ruler 4—present invention 6—notch or groove 8—through-hole or hole 10—pencil 12—point

### DETAILED DESCRIPTION OF THE INVENTION

A conventional ruler FIG. 1 in its present shape is a rectangular sheet of elongated rigid material made of wood, plastic or metal such as aluminum.

The edge of the conventional ruler FIG. 1 has lines that are equally spaced into fractions of an inch or millimeters as shown in FIG. 1.

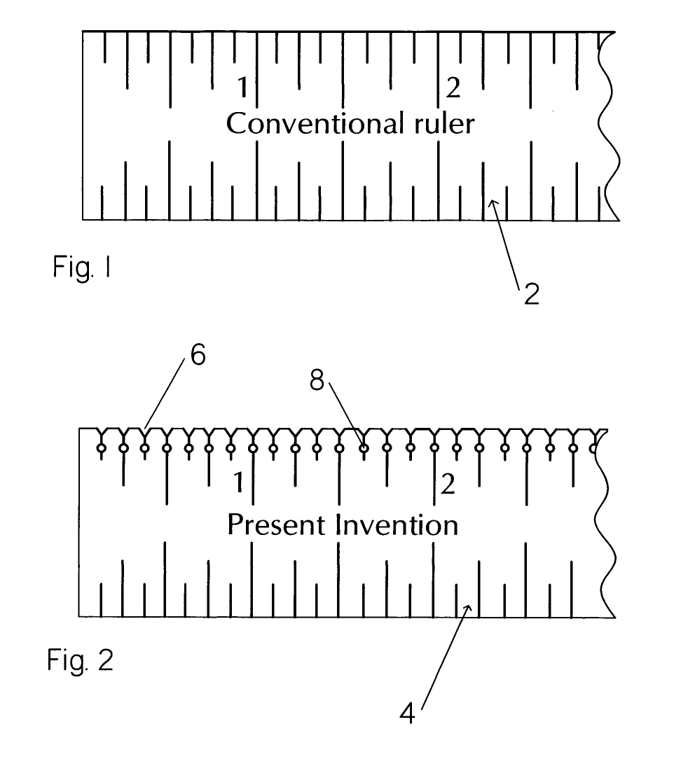

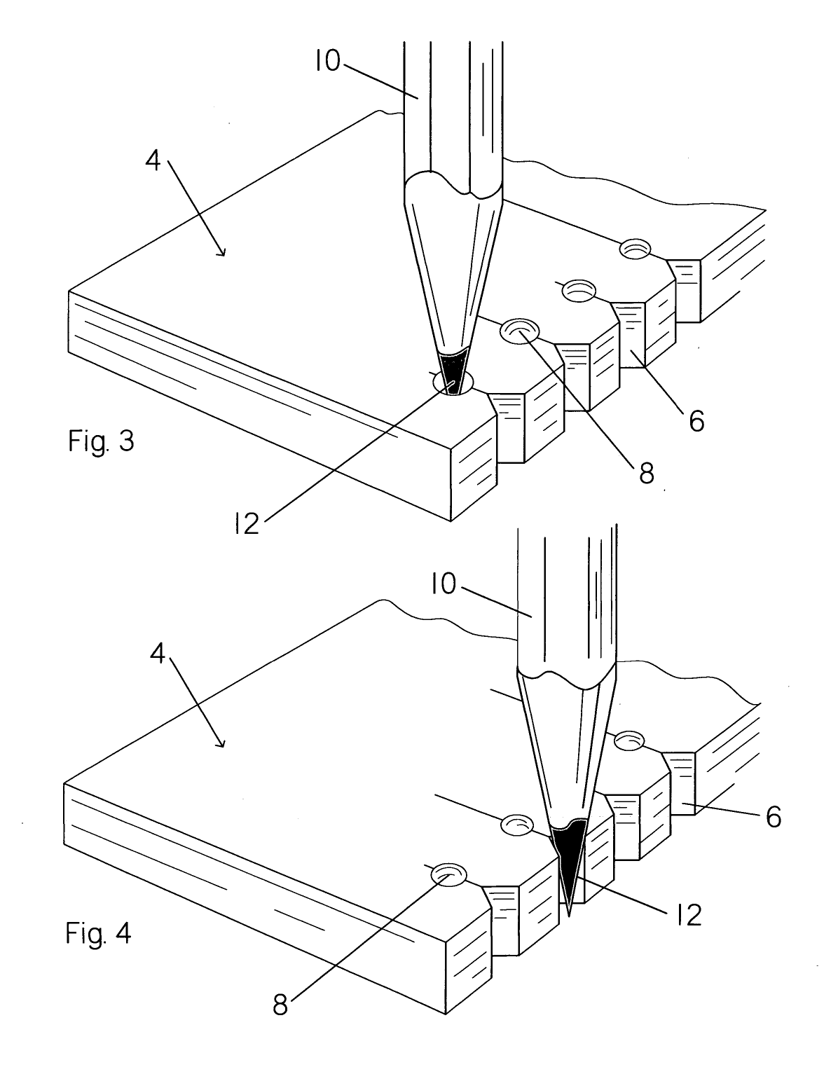

FIG. 2 shows the present invention 4. The present invention 4 can also be made of any suitable rigid material that the conventional ruler FIG. 1 is made of such as wood, plastic or metal. One edge of present invention 4 has the addition of a series of notches, grooves or indents 6 that are accurately machined and equally spaced longitudinally at each inch and fraction of an inch or millimeter. The notches or grooves 6 are sized to fit the point of a conventional marking instrument or pencil 10. With the notches sized to fit the point of a marking instrument, the point 12 will make a mark accurately in the center of the notch or groove 6.

The present invention FIG. 2 on the same end of the ruler that has notches or grooves 6 is a series of through-holes 8.

Each through-hole 8 is equally spaced longitudinally at each inch and fraction of an inch or millimeter.

The holes 8 are accurately drilled to fit the point of a conventional marking instrument or pencil 10 and with the insertion of point 12 make an accurate mark in the center of through-hole 8.

The advantage of having notches or grooves 6 and holes 8 on the present invention 4 is it enables a person to repeatedly and quickly mark accurately at each division on the ruler that has a notch 6 or through-hole 8.

Converting the conventional ruler FIG. 1 into an accurate measuring and marking instrument.

The close-up in FIG. 3 clearly shows point 12 making a mark in hole 8 at one of the divisions on the present invention 4.

FIG. 4 also a close-up of the present invention 4 clearly shows point 12 making a mark in notch or groove 6.

In FIG. 4 we can see that the sharpened pencil point 12 is tapered. The through-holes 8 and notches or grooves 6 can also have a taper, but this is not necessary.

When hole 8 and notch or groove 6 is the approximate size of the mid-section of point 12 an accurate mark will be made each time. This can be clearly viewed in FIG. 4 point 12.

The present invention 4 with the simple inclusion of notches 6 and through-holes 8 corrects the disadvantageous of the tired old ruler FIG. 1.

### CONCLUSION, RAMIFICATIONS, AND SCOPE

With the simple addition of the notches 6 and holes 8 the conventional ruler FIG. 1 is converted into an accurate measuring and marking tool.

The preferred embodiment of the present invention is illustrated in FIG. 2.

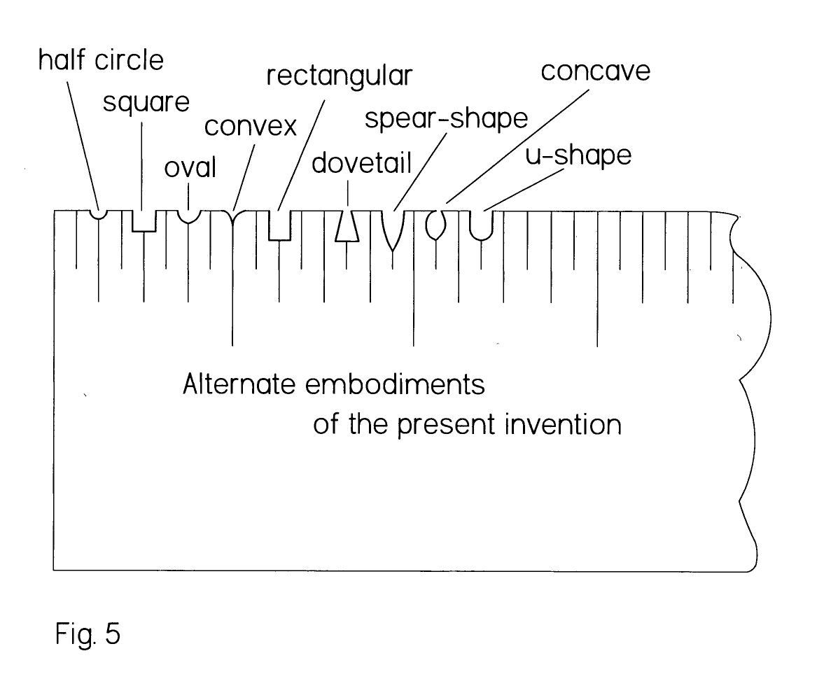

Illustrated in FIG. 5 are alternate embodiments of the present invention. The different shapes such as the half circle, square, oval, convex, rectangular, dovetail, spear-shape, concave and u-shape can produce similar results as the preferred embodiment FIG. 2. The shape of the ruler can be an angle, triangle, circle or curve with notches, grooves and through-holes somewhere on the body of the ruler. The notches and holes can be located on the same edge as seen in the present invention FIG. 2 or on opposite edges, these are all modifications of the present invention.

While the present invention FIG. 2 has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

I claim:

1-10. (canceled)

11. A method of making an improved ruler for measuring and marking material, comprising:
(a) providing a sheet of elongated rigid material of a predetermined size and shape and having equally spaced transverse indicia lines along each edge,
(b) having on one edge and precisely centered on said indicia lines are equally spaced v-grooves sized to fit the point of a marking instrument,
(c) including and precisely centered on said v-grooves are equally spaced round holes sized to fit the point of said marking instrument,
whereby said sheet of rigid material with the inclusion of said v-grooves and said round holes both precisely centered on said indicia lines, enable a person to select said v-grooves or said round holes to accurately and repeatedly measure and mark their material at each said indicia line, thereby eliminating normal human error.

1-11. (canceled)

12. A method of using an improved ruler for measuring and marking material,
comprising the steps of:
(a) providing said ruler including,
a sheet of elongated substantially rigid material of a predetermined size and shape and having equally spaced traverse indicia lines along each edge,
one said edge having v-grooves precisely centered on said indicia lines,
said v-grooves sized to fit the point of a marking instrument,
equally spaced round holes sized to fit the point of said marking instrument and precisely centered on said v-grooves,
(b) positioning said ruler on a work surface,
(c) selecting a portion of said v-grooves or said round holes to accurately and repeatedly measure and mark said work surface at each corresponding said indicia line whereby normal human error is eliminated.
